(19) United States
(12) Patent Application Publication
(10) Pub. No.: US 2021/0204747 A1
(43) Pub. Date: Jul. 8, 2021

(54) BEVERAGE BREWING APPARATUS AND METHOD

(71) Applicant: UAB "ESPRESA", Vilnius (LT)

(72) Inventor: Ernest RUDIK, Vilnius (LT)

(73) Assignee: UAB "Espresa", Vilnius (LT)

(21) Appl. No.: 16/765,670

(22) PCT Filed: Jan. 5, 2018
(86) PCT No.: PCT/IB2018/050075

§ 371 Date: May 20, 2020

(30) Foreign Application Priority Data
Nov. 22, 2017 (LT) LT-2017-537

(51) Int. Cl. A47J 31/00; A47J 31/02; B65D 85/816; A47J 31/057

(52) U.S. Cl. CPC A47J 31/005; A47J 31/0573; B65D 85/816; A47J 31/02

(57) ABSTRACT

An apparatus and method to prepare food products that need to be filled with hot water, is provided. The apparatus includes a water preparation device and a cup of special construction. The construction of the cup is suitable for placing water and dry substances, preparations for brewing beverages. The device pumps water from the cup, heats it, combined with a container of dry substances of the beverage, the pressure of water is increased to ˜3.5 bar., water penetrates through dry food substances, acquires the properties of the beverage, enters the cup. The present invention provides the beverage brewing apparatus and method for use in vehicles, the cup can be inserted into and/or removed from the device, the device is operated by 12V DC, has power storage means, the water supplied with the cup may be specially processed, prepared to convey the particular flavor of food.

### FIELD OF THE INVENTION

The invention relates to the preparation of food products, and in particular the preparation apparatus of food for which hot water is required, consisting of a cup and a water preparation device; and a food preparation method using the said preparation apparatus.

### DESCRIPTION OF THE RELATED ART

This description provides a technical solution for preparing food, and in particular for brewing beverages, coffee, when dry food substances is required to be filled with hot water for brewing. The solution consists of a water preparation device, a cup of special construction for use with the said apparatus and a method of brewing the beverage. The substances and water for brewing the beverage are placed in the cup, the device heats up the water, increases the pressure of the heated up water, and directs it to the container of substances. The apparatus is designed for use in vehicles; the brewing process is completely automatic, without user engagement.

The patent document US2005211102 (A1) (published on Sep. 29, 2005) provides a coffee or other hot beverage brewing system where at the initial step of brewing all the substances (including water) necessary for brewing the beverage are placed in a beverage container of special construction. Water in the cup is heated up in a coffee vending machine using a microwave-operated heater. Some people do not use products that are heated by microwave ovens, thus this type of coffee brewing can lower the amount of coffee they buy; on the other hand, coffee lovers are very sensitive to the taste of coffee, and processing of all substances of beverages using microwaves can adversely affect the taste of the beverage. Another deficiency of the quoted document is the extremely complex construction of the cup, the method of brewing comprising many steps and, moreover, these steps must be performed by a human. The high number of steps of brewing requires deepening, concentration in brewing the beverage—this can also lead to a smaller amount of buyers of the beverage. From the construction of the cup it can be understood that even a little damage to the construction when preparing the cup for heating or when heating the cup can lead to an unexpected outflow of the liquid, and other significant deviations from the brewing process that may result in the beverage brewing process being interrupted without having brewed the beverage. There is also no possibility to accurately select and set the temperature of the liquid that infuses coffee powder, which changes the taste of the beverage.

The patent document US20060272510 (A1) (published on Jul. 12, 2006) provides a cup of coffee (or other beverage) with a lid, whose construction allows the dry substances for brewing the beverage to be placed in the lid, which are disposed of with the lid after brewing the beverage. Compared to the solution provided in this description, the solution provided in the cited document differs in the construction of the cup. The solution provided in the cited document is not suitable for any coffee brewing machines, the beverage needs to be made by yourself, water is not provided with the cup, it is not described the way water is heated up for the beverage, when the lid with substances of the beverage is disposed of, the cup is left without the lid, the possibility to spill the beverage arises, i.e. compared with a covered cup, it is not so convenient and safe to drink the beverage. Also, the cup is not intended for automatic beverage brewing.

To sum up, the listed solutions of the related art have the following deficiencies:
the cup is not intended for automatic beverage brewing;
the complicated construction of the cup, even with a small change in the construction, its damage may lead to a breakdown of the brewing method without brewing the beverage;
the beverage brewing has many steps which have to be performed by a human;
there is no possibility to accurately select the temperature of the beverage;
no water is provided with the cup;
the result (flavor of the beverage brewing depends on skills of a brewer, the quality of water.

This description provides a new technical solution that does not have the above-mentioned deficiencies.

### SUMMARY OF THE INVENTION

This description provides a new apparatus and a method to prepare food that need to be filled with hot water, such as tea, soup, broth, and especially coffee (hereinafter —“the beverage”). The new apparatus includes a water preparation device and a cup of special construction. The construction of the cup is suitable for placing water and dry substances, preparations for brewing beverages. The device pumps water from the cup, heats up it to the required temperature, combined with a container of dry substances of the beverage, the pressure of water is increased to ˜3.5 bar., water penetrates through dry food substances, acquires the properties of the beverage, enters the cup.

The present invention provides the beverage brewing apparatus and method for use in vehicles, the construction of the cup allows the cup to be inserted into and/or removed from the device from the four sides of the device, the device is operated by 12V DC, has power storage means to reduce the peak load of the power supply circuit, the water supplied with the cup may be specially processed, prepared to convey the particular flavor of food.

### BRIEF DESCRIPTION OF THE DRAWINGS

FIG. 1 shows a schematic view of the cup of the present invention.

FIG. 2 shows a view of the device of the present invention

The presented figures are more illustrative, scale, proportions and other aspects do not necessarily correspond to the actual technical solution.

### DETAILED DESCRIPTION

This description provides a solution to prepare food that need to be filled with hot water. The said food may be coffee, tea, soup, broth, porridge or other products (hereinafter —“the beverage”). The solution is applicable to vehicles such as cars, buses, airplanes, ships, trains, etc., but can also be easily adapted to a different environment where the supply of power to a beverage brewing apparatus is possible.

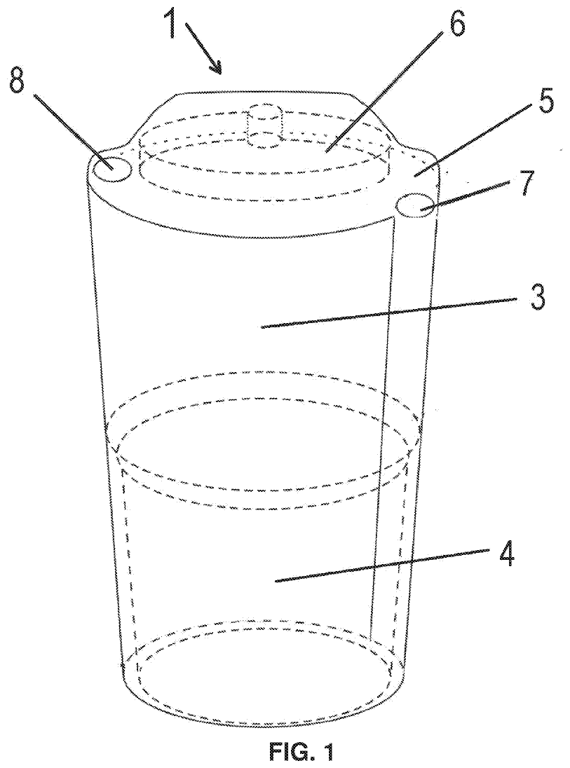

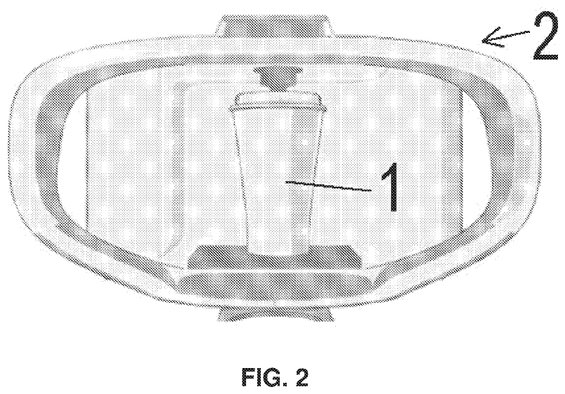

The said solution consists of a hot water preparation device (2) (FIG. 2) (hereinafter —“the device”), a cup (1) (FIG. 1) of special construction and a method of beverage brewing. The construction and functions of the cup (1) and the device (2) are intended to use both elements (the cup (1) and device (2)) together; separately used elements do not produce the required technical effect.

This description provides the cup (1) containing at least the following components:
an outer vessel (3) which combines other components of the construction of the cup (1), contains the brewed beverage inside,
a cold water tank (4);
a lid of the outer vessel (5);
a container of dry food substances (6). The outer vessel (3) of the cup resembles the usual disposable cup of coffee, i.e. a slightly narrowing hollow cylinder. In other embodiments, the shape of the outer vessel (3) may be different. The outer vessel (3) is made of a material resistant to hot water, which may come into contact with foodstuffs—cardboard, plastic or other similar material may be used for this purpose. The outer vessel (3) combines all the elements of the cup (1) into the whole: a cold water tank (4), a lid (5), contains the brewed beverage inside.

The cold water tank (4) is placed in the inner lower part of the outer vessel (3) and occupies a part of the outer vessel (3). The form of the water tank (4) resembles the shape of the outer vessel (3), in particular the lower part of the outer vessel (3). The water tank (4) is tightly separated from the upper part of the outer vessel (3). The water tank (4) can be realized as a separate tank, placed inside the outer vessel (3), in the lower part. It is also possible to realize the cold water tank (4) using the outer vessel (3), by separating the part of the outer vessel (3) tightly for the liquid. A combination of both aspects of the construction is possible: the inner part of the outer vessel (3) is tightly separated, i.e. the inner part of the outer vessel (3) is divided into two interconnected parts, and in the lower part the cold water tank (4) is placed. A requirement for the material of water tanks (4) is liquid tightness, suitability for use in contact with food.

A pipe (7) through which water can flow from the tank (4) is connected to the cold water tank (4). In the case of the present invention, the pipe (7) is tightly attached to the water tank (4); in other case, it can be made of a material integral with the tank (4), water can flow through the pipe (7) from the tank (4). The said pipe (7) extends beyond the wall of the outer vessel (3) or through the lid (5) at its other end than that which is attached to the water tank (4). Prior to the start of brewing the beverage, the said pipe (7) must be tightly closed, the water in the tank (4) cannot penetrate, pass through the pipe (7). When the cup (1) is inserted into the device (2), before water begins to flow from the tank (4) to the device (2), the closure must be removed. In one embodiment, the said closure of the pipe (7) may be a valve that prevents the flow of water through the pipe (7), and when the device (2) is connected, the valve opens, the water can flow through the pipe (7).

The lid (5) is attached on the upper side of the outer vessel (3). The lid (5) is attached indistinguishably from the outer vessel (3), it can be made of a material integral with the outer vessel (3). Alternatively, the lid (5) can be easily separated from the outer vessel (3). In one embodiment, the pipe (7) through which the water flow from the tank (4) to the device (2), can protrude through one of its ends through the lid (5). The lid (5) has a hole (8) for drinking. The lid (5) is made of high-strength plastic that can come into contact with food, which does not change its properties in contact with high temperature water.

The lid (5) has the container of food substances (6) that contains dry food substances from which the beverage is made. The lower wall of this container of food substances (6) consists of a filter through which the liquid can penetrate, but which holds dry food substances inside the container (6). The container of food substances (6) has a hole through which water from the device (2) enters the container of food substances (6). The hole may have a valve or other hole closure which passes the liquid into the inside of the container of food substances (6), but food substances are held inside the container (6). The hole has technical means, couplings, with which the pipe (2) is tightly connected to the container of food substances (6), this connection is designed in such a way that water can flow through the connection without penetrating to the outside at a pressure of at least 3.5 bar. The inner shape of the container of food substances (6) resembles the shape of a small cylinder, tablet. The said container of food substances (6) is realized in the lid (5), in addition to the said openings for holding hot water and the contents of the filter in the container (6), all the other walls of the container (6) and their connections are sealed, waterproof. The container (6) must be able to withstand a pressure of at least 3.5 bar. The container of food substances (6) is made of high-strength plastic that helps the container (6) to keep the shape and integrity at an inner pressure of at least 3.5 bar. The filter of food substances for holding food substances is adapted to create the said pressure of the liquid.

In another embodiment, the cup (1) may be without the separate cold water tank (4). In this case, the inner part of the outer vessel (3) is integral, without separation, where water is placed before brewing the beverage. This inner part of the outer vessel (3), like the cold water tank (4), has the pipe (7) through which the device (2) can pump the water for heating.

Another component of this solution for brewing the beverage is the hot water preparation device (2). The device (2) pumps water from the cold water tank (4), heats up it to a temperature of at least 95 degrees of Celsius or other temperature necessary for brewing the beverage, and with the pressure (in the case of the present invention—3.5 bar), releases water into the container of food substances (4) of the cup (1).

The hot water preparation device (2) has at least the following main parts:
a housing,
a moving connection with the cup (1),
a power circuit with power storage means,
a liquid heating component,
a liquid pump to increase the pressure of water.

In addition to the above components that perform the basic functions of the beverage brewing in the case of the present invention, there may be other elements, components that ensure the proper operation of the device (2) according to the instructions.

The housing of the device (2) combines, contains all the components of the device (2). In the case of the present invention, the shape and functions of the device (2) are realized so that the cup (1) can be placed into the device (2) and taken from the device (2) from at least four sides of the device (2). This construction provides a convenient way to use the device (2), especially if it is located in the middle of the vehicle, for example in the middle of the car, between the front seats.

The moving connection with the cup is designed to connect the device (2) with the cup (1), to transfer the liquid between the device (2) and the cup (1). When the cup (1) is located at the place of the device (2) where the beverage brewing can be started, the moving part of the device (2) descends to the lid (5) of the cup (1), and pipes and hoses in the moving connection are tightly connected to the pipe in the lid (5) of the cup (1) from the cold water tank (4) and to the pipe for feeding hot water to the container of food substances (6). The connection of the moving connection and in particular the connection of its pipe for transferring water to the container of food substances (6), with the connection of the container of food substances (6) of the cup (1) must allow to transfer water from the device (2) to the cup (1) at a pressure of at least 3.5 bar.

The power circuit of the device (2) with power storage means ensures the proper power supply from the power circuit of the vehicle to all electrical components of the device (2). When the power supply to the device (2) is provided from the power system of the vehicle, where cannot be long-lasting high-power load, the device (2) has power storage means. Power storage means accumulate power from the device (2) of the vehicle during non-use and deliver power to the device (2) when the device (2) brews the beverage. In this way, the power system of the vehicle is protected from high power consumption fluctuations. In the case of this invention, the power circuit of the device (2) is adapted to operate by connecting the 12V DC power supply.

The liquid heating component of the device (2) consists of liquid transfer means, through which water is fed from the cup (1) to the water tank of the heating component, and from it into the container of food substances (6) of the cup (1). The water tank of the heating component contains all the water which went out of the tank (4) of the cup, it is heated up in the container to the required temperature for brewing the beverage and transferred to the liquid pump. In one embodiment, the heating component is realized with the ability to set the required temperature of the heated liquid.

The liquid pump increases the water pressure and directs the water towards the container of food substances (6) in the cup (1). In order to prepare certain types of coffee beverages, to give the needed flavor to the coffee, it is needed to increase the pressure of water. In the case of this invention, the liquid pump increases the pressure of the liquid to 3.5 bar.

The method of brewing the beverage using the described apparatus, the water preparation device (2) and the cup (1) comprises following steps:
the cup (1) for brewing the beverage is placed in the water preparation device (2),
the water preparation device (2) is connected to the cup (1) by pipes, hoses and connecting elements: one of pipes of the device (2) is connected to the pipe of the cup (1), through which the water flows from the cold water tank (4) to the device (2); the other pipe (2) of the device (2) is connected to a hole through which the water prepared in the device (2) flows into the container of food substances (6),
the water which entered the device (2) from the cup (1) is heated to the required temperature for brewing the specific beverage (in the case of this invention, at least 95 degrees of Celsius); —when it is heated to a set temperature, the pressure of water is increased and the water is supplied to the container pf food substances (6) of the cup, in which the water acquires the properties of the beverage, penetrates through the filter of the container of food substances (6) and enters the inner part of the outer container (3) of the cup (1);
when the entire water in the cold water tank is heated up in the device (2) and when the entire water passes through the container of food substances (6), it enters the inner part of the outer container (3) of the cup (1), the beverage is brewed, the cup (1) is disconnected from the device (2), the cup (1) can be removed from the device (2).

In order to illustrate and describe the invention, the description of the most suitable embodiments is presented above. This is not a detailed or restrictive description to determine the exact form or embodiment. The above description should be viewed more than the illustration, not as a restriction. It is obvious that specialists in this field can have many modifications and variations. The embodiment is chosen and described in order to best understand the principles of the present invention and their best practical application for the various embodiments with different modifications suitable for a specific use or implementation adaptation. It is intended that the scope of the invention is defined by the definition added to it and its equivalents, in which all of these definitions have meaning within the broadest limits, unless otherwise stated.

In the embodiments described by those skilled in the art, modifications may be made without deviating from the scope of this invention as defined in the following definition.

1. A beverage brewing apparatus comprising a cup and a water preparation device, where the cup (1) comprises:
an outer vessel,
a cold water tank in which water is placed for brewing the beverage;
a lid of the outer vessel that covers the outer vessel, contains substances for brewing the beverage,
and the water preparation device comprises:
a housing,
a moving connection with the cup for transferring water between the cup and the device,
a power circuit with power storage means to power electrical receivers of the device,
a liquid heating component to warm water to the temperature suitable for brewing,
a liquid pump for increasing the pressure of water and directing it to a container of food substances,
wherein the water preparation device and the cup have technical means, the couplings with which the pipe of the device for supplying the heated water is tightly connected to the container of food substances, this connection is designed in such a way that water can flow through the connection without penetrating to the outside at a pressure of at least 3.5 bar.

2. The beverage brewing apparatus according to claim 1, wherein the container of food substances in the cup is made of high-strength plastic that can withstand its shape and integrity when an inner pressure is at least 3.5 bar.

3. The beverage brewing apparatus according to claim 1, wherein the housing of the water preparation device is such that the cup can be placed into the device and taken from the device from at least four sides of the device.

4. The beverage brewing apparatus according to claim 1, wherein the lid with the outer container is attached indelibly.

5. The beverage brewing apparatus according to claim 1, wherein the upper wall of the cup of the container of food substances contains a filter through which the liquid can penetrate, but which holds dry substances in their container.

6. The beverage brewing apparatus according to claim 1, wherein the container of food substances is made of high-strength plastic, which helps the container to maintain its shape and integrity at an inner pressure of at least 3.5 bar.

7. The beverage brewing apparatus according to claim 1, wherein the device is powered by a direct current with voltage of 12 V.

8. The beverage brewing apparatus according to claim 1, wherein the power circuit of the device comprises power storage means that accumulate the power during non-use of the device and delivers power when the device brews the beverage, thus reducing the peak power loads in the power supply system of the vehicle.

9. The beverage brewing apparatus according to claim 1, wherein the heating component of the device is realized with the ability to set the required temperature of the heating liquid.

10. A method of brewing the beverage is implemented by using the apparatus according to claim 1, comprising the following steps of brewing:
the cup for brewing the beverage is placed in the water preparation device,
the water preparation device is connected to the cup (1) by pipes, hoses and connecting elements: one of pipes of the device is connected to the pipe of the cup, through which the water flows from the cold water tank to the device; the other pipe of the device is connected to a hole through which the water prepared in the device flows into the container of food substances,
the water which entered the device from the cup is heated to the required temperature for brewing the specific beverage (in the case of this invention, at lest 95 degrees Celsius);
when it is heated to a set temperature, the pressure of water is increased and the water is supplied to the container of food substances of the cup, in which the water acquires the properties of the beverage, penetrates through the filter of the container of food substances and enters the inner part of the outer container of the cup;
when the entire water in the cold water tank is heated up in the device and when the entire water passes through the container of food substances, it enters the inner part of the outer container of the cup, the beverage is brewed, the cup is disconnected from the device, the cup can be removed from the device.
